(19) United States
(12) Patent Application Publication
(10) Pub. No.: US 2014/0090448 A1
(43) Pub. Date: Apr. 3, 2014

(54) DETECTION APPARATUS FOR DETECTING LEAKS IN AN AIR-TIGHT COMPONENT AND RELATED DETECTION PROCESS

(71) Applicant: ENG SERVICE S.R.L., Darfo Boario Terme (IT)

(72) Inventor: Giacinto Bassani, Bornato di Cazzago San Martino (IT)

(73) Assignee: ENG SERVICES S.R.L., Darfo Boario Terme (IT)

(21) Appl. No.: 14/116,877

(22) PCT Filed: May 11, 2012
(86) PCT No.: PCT/IB12/52360

§ 371 Date: Nov. 11, 2013

(30) Foreign Application Priority Data
May 12, 2011 (IT) PD2011A000150

(51) Int. Cl. G01M 3/20

(52) U.S. Cl. CPC G01M 3/202
USPC 73/40.7

(57) ABSTRACT

A detection apparatus for detecting leaks in items using tracer gas. The apparatus comprises a plurality of cells which are provided so as to receive an item to be subjected to separate phases of a detection process in order to detect the leaks, and a detection system using tracer gas provided to be connected via suitable connection devices to each cell of the plurality of cells in order to carry out the various phases of the detection process, wherein the cells are positioned on a moving device in order to be successively moved towards separate work stations of the apparatus in order to be subjected to the separate phases of the detection process.

### TECHNICAL FIELD

The present invention relates to an apparatus for detecting leaks in an air-tight component and a relevant detection process with a tracer gas, in a version helium. The present invention is used, for example, in the sector of controlling metal wheel rims, particularly of aluminium, for vehicles and motor vehicles, and for controlling friogenic devices.

### TECHNOLOGICAL BACKGROUND

There are various fields in which it is important to ensure the air-tightness of the item produced and, therefore, the entire production or all the items produced are subjected to control. In fact, any item, even if it is produced industrially, cannot be considered to be completely free from defects (holes, porosity, etc.) or to have complete air-tightness. Therefore, the items are subjected to non-destructive air-tightness control tests in order to verify whether they do or do not have the features required, that is to say, a degree of imperfections less than those provided for by the reference standards of the intended use.

The imperfections are defined in terms of a leak rate; the smaller the leak rate, the greater will be the air-tightness requirements of the item, and vice versa. For each specific final application of the item, for example, industrial, mechanical, chemical or aerospatial applications, there is defined a permissible leak rate.

In accordance with the leak rate to be detected and the measurement accuracy required by the specific application, it is possible to use various test methods.

In fields in which it is necessary to measure a very low leak rate (less than 2×10⁴ Pa*m³/s), it is known to use the test method referred to as the “helium test,” that is to say, the control of items by the use of helium (He) as a tracer gas. Since helium has an extremely low molecular mass, it being the smallest after hydrogen, this also allows detection of leaks of 10⁻¹⁰ Pa*m³/s, and furthermore it is not dangerous because it is inert, unlike hydrogen.

U.S. Pat. No. 5,850,036 describes a test apparatus for vehicle wheel rims subjecting the wheel rims to a differential pressure of helium. The apparatus which is shown schematically in FIG. 1 and designated (100) comprises a conveyor belt for transporting the wheel rims (140) to be examined to an examination cell (300) which is operatively connected to a mass spectrometer (220) in order to detect test gas leaks by means of the first tube (720), and a discharge belt for transporting the examined wheel rim (140) from the examination cell (300) to a first discharge zone if it has passed the test or to a second discharge zone if it has not passed the test. The apparatus (100) further comprises a gripper device for taking the wheel rim (140) from the transport belt, loading it in the cell (300) and taking it from the cell for the purpose of the test in order to position it on the discharge belt.

The apparatus (100) further comprises a processor which is operatively connected to the spectrometer (220) in order to receive the signal relating to the leak rate of the wheel rim (140) being examined and to generate a command for the final destination zone of the wheel rim (140) on the basis of the value of the leak rate detected.

The examination cell (300) comprises a fixed lower plate (520), on which the wheel rim (140) is supported for the examination, a bell-like member (600) which can be moved with respect to the lower plate (520), a movable upper plate (540) which can be moved inside the bell-like member (600) between an examination position, in which the movable upper plate (540) is lowered onto the wheel rim (140) in order to define an outer housing (660) of the wheel rim (140) that is closed in an air-tight manner, and a raised position in which the movable upper plate (540) is raised with respect to the wheel rim (140). The upper plate (540) and the bell-like member (600) can be moved by means of actuators (560) and (610), respectively. The wheel rim (140) defines with the lower plate (520) an inner housing (580) which is connected by means of the first tube (720) to a pump in order to create a desired level of pressure reduction in the inner housing (580) and in the spectrometer (220). The outer housing (660) is connected to a test gas source (700), that is to say, a mixture of air/helium, by means of a second tube (680). Air-tight seals are provided in the cell (300) in order to seal the outer housing (660) and inner housing (580).

In the air-tightness test, the pressure reduction is produced in the inner housing (580) and outer housing (660) after reaching a predetermined level of pressure reduction in the inner housing (580) and outer housing (660), the test gas is introduced into the outer housing (660), with a differential pressure being applied to the wheel rim (140). The spectrometer (220) being activated, any leak rate of test tracer gas from the outer housing (660) through the wheel rim (140) to the inner housing (580) is determined.

After the leak rate has been determined, the test gas contained in the outer housing (660) is recovered and, after reaching a predetermined pressure reduction level, the upper plate (540) and the bell-like member (600) are raised, the wheel rim (140) is taken by means of the gripper device and moved towards the destination provided for in accordance with the results of the test carried out.

In order to increase the productivity of the apparatus (100), a second test line is provided comprising a second test cell which is generally similar to the first test cell, a second mass spectrometer, a second test gas source and connected to conveying, discharge and gripper devices, respectively. The first and second cells may operate in parallel.

However, the apparatus described in U.S. Pat. No. 5,850,036 has some drawbacks discussed below. The provision of two separate test lines for increasing the productivity of the apparatus considerably increases the plant costs, the overall dimensions of the apparatus (100) and the consumption of helium for the operation of the apparatus.

As mentioned, it is necessary to bring about a suitable level of pressure reduction in the outer housing (660) before introducing the test gas and, subsequently, when the test gas contained in the outer housing (660) is recovered. Those operations take a specific time which constitutes the main factor in the total duration of the process: the greater the level of pressure reduction brought about, the greater the time required and therefore the duration of the detection process, with a reduction in productivity, but the consumption of test gas and the pollution of the measurement environment will be lower and the precision of the detection operations carried out will be greater.

In order to increase the productivity of the apparatus, with the total duration of the test cycle being limited, it is necessary to operate at a lower level of pressure reduction; this involves a considerable reduction in the precision of the detection operations carried out owing to dilution of the helium in the test mixture. This further involves the dispersion of helium in the measuring environment when the bell-like member is opened, producing background noise which reduces the sensitivity of the detection operations carried out, invalidating the precision and reliability thereof in addition to increasing the consumption of tracer gas. Those dispersions further involve a substantial increase in the process costs owing to the high cost of helium.

Therefore, in order to avoid excessive consumption of helium, there are used helium/air mixtures with a low content of helium, further reducing the sensitivity of the detection operations carried out.

The limitations set out above are particularly evident when tests are carried out on items for which it is necessary to have a very high measurement precision and/or when tests are carried out on items having such geometries as to require an increase in the time necessary to carry out at least one of the phases of the test process, typically the phase in which the pressure reduction is brought about in the test cell.

U.S. Patent Application Publication No. 2005/0115305 describes a test apparatus for items and a relevant method. In the apparatus of US2005/0115305, the bell-like members to be tested are introduced into test cells, respectively, the cells with the bell-like members and the test equipment are mounted on a rotatable platform and the process phases are carried out during the rotation of the platform itself. Therefore, a detection process is carried out continuously, that is to say, the detection process is carried out without interrupting the rotation of the platform. A pump for the pressure reduction is associated with each test cell.

That apparatus also has some limitations. In particular, that apparatus is not flexible and does not allow a variation of only the duration of one or some phases of the test process. Furthermore, that apparatus is not suitable for processing items having substantial dimensions and/or complex geometries and/or for which it is necessary to have a high level of test precision because it would be necessary to have a rotatable platform having dimensions which are too high to transport all the equipment necessary.

### SUMMARY OF THE INVENTION

The present invention describes a detection apparatus for detecting leaks in an air-tight component and a related detection process using a tracer gas which are configured so as to overcome the limitations set out with reference to the cited prior art.

In particular, an object of the invention is to provide a detection apparatus which has a high level of productivity and, with productivity being the same, a reduced spatial requirement with respect to known apparatuses.

An object of the invention is to provide an apparatus for detecting leaks in an item and a related process which have a test cycle time which is comparable with the production frequency of the item being tested to which the production process relates.

Another object is to provide an apparatus which has a high level of detection sensitivity and repeatability without consequently increasing the time required to carry out the detection. Another object is to provide an apparatus capable of producing and maintaining optimum test conditions, at the same time maintaining high levels of productivity.

Another object is to provide an apparatus in which the background noise of the tracer gas is eliminated or drastically reduced, that is to say, the concentration of tracer gas in the environment and consequently in the measurement environment.

Another object is to provide a detection process, in which the phase of recovering the tracer gas is optimized in order to minimize the consumption of the gas itself, at the same time maintaining high levels of productivity.

These objects are achieved by the present invention by means of a detection apparatus and a detection process with a tracer gas constructed in accordance with the detailed description below.

### BRIEF DESCRIPTION OF THE DRAWINGS

The features and advantages of the invention will be better appreciated from the detailed description of preferred embodiments thereof, illustrated by way of non-limiting example with reference to the appended drawings, in which:

FIG. 1 is a schematic view of the apparatus for detection with tracer gas of the prior art;

FIG. 2 is an operating diagram of a detection apparatus according to the invention;

FIGS. 2A and 2B are operating diagrams of two possible variants of the detection apparatus of the invention; and

FIGS. 3 to 6 are schematic views of a first work station A′, a second work station B′, a third work station C′ and a fourth work station D′ of the apparatus of FIGS. 2, 2A and 2B, respectively.

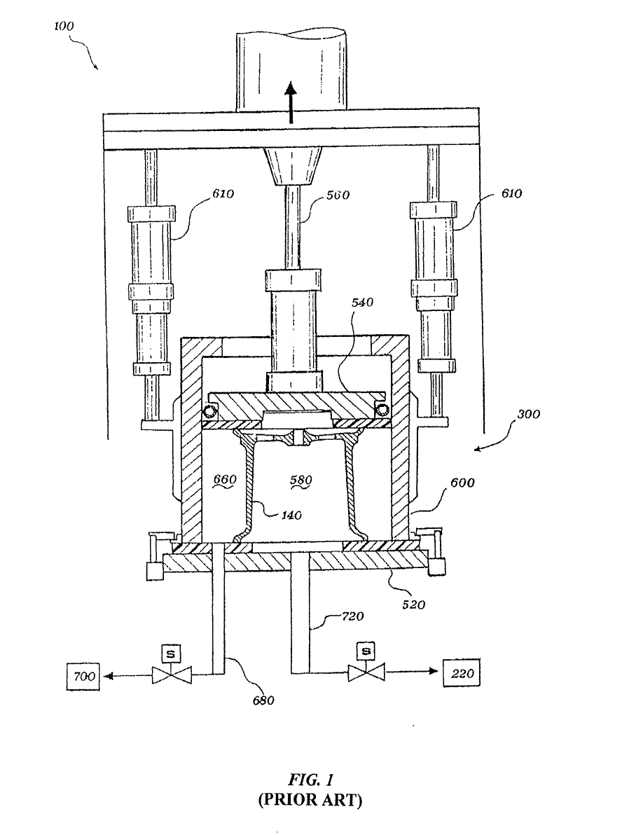

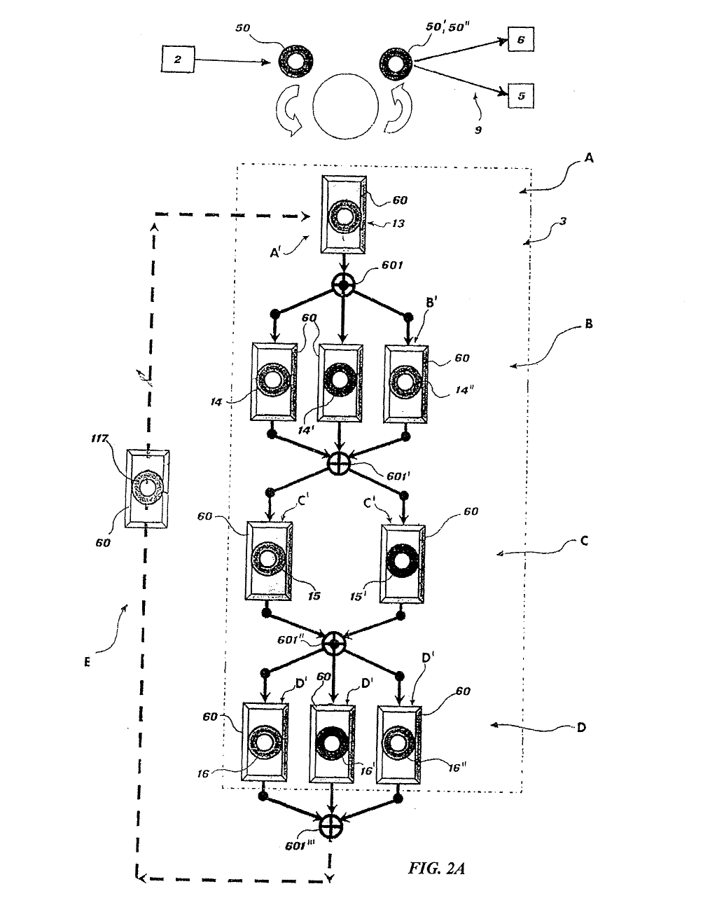

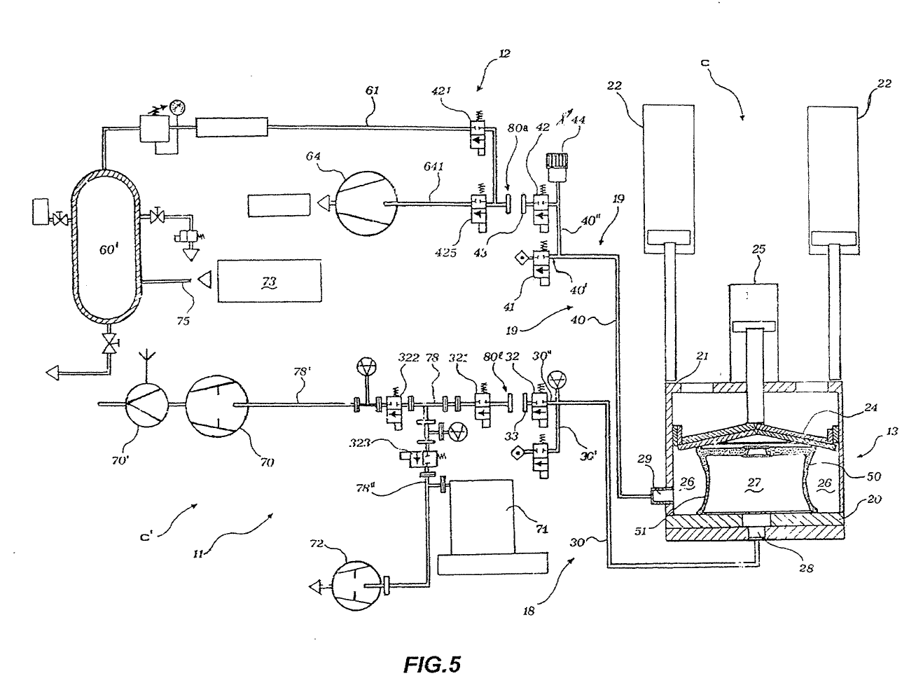

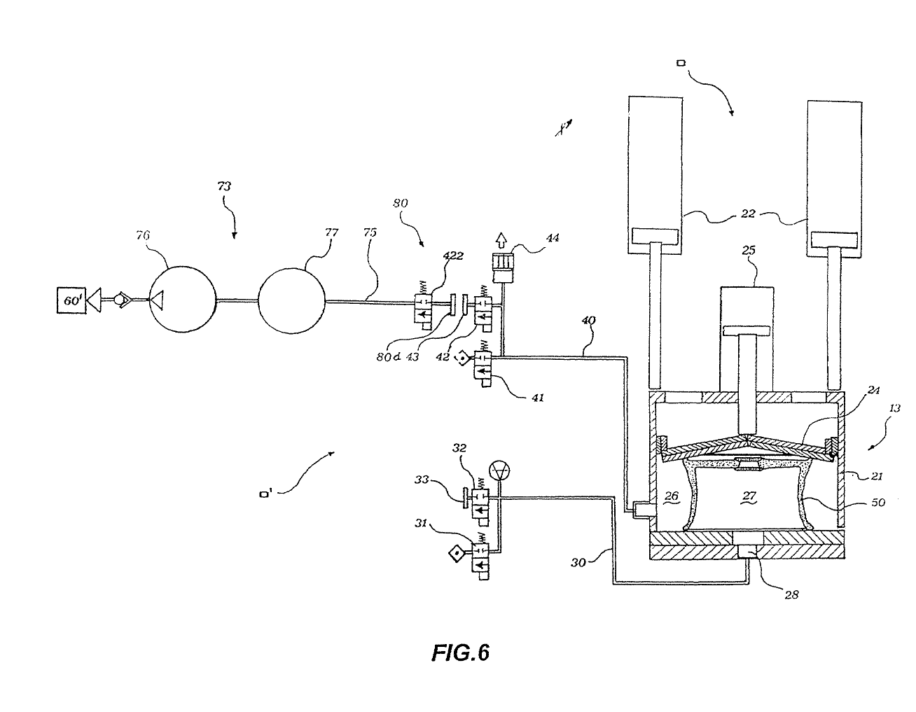

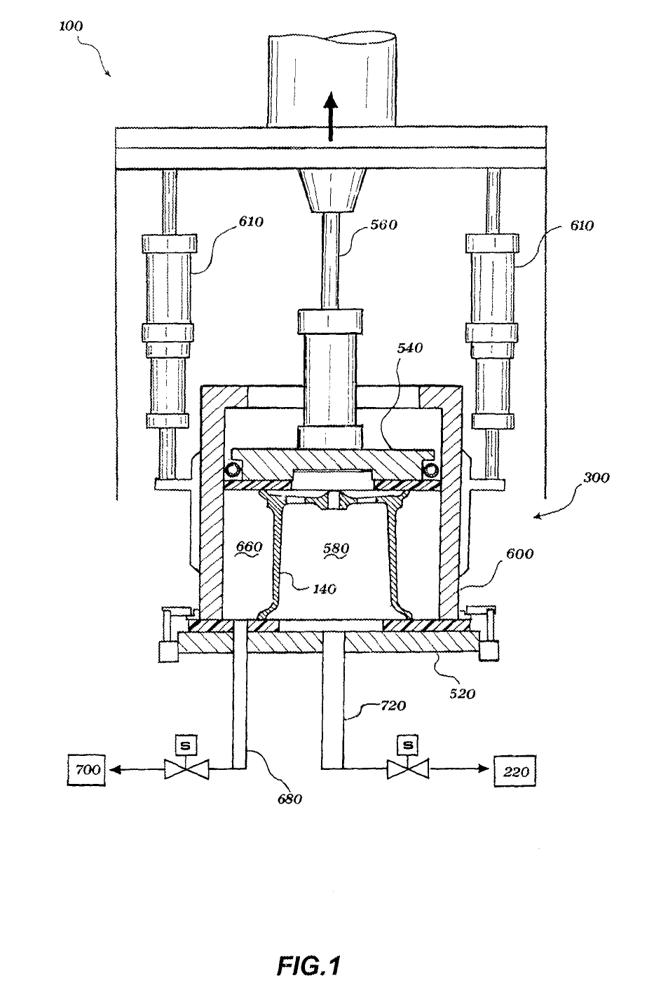

### PREFERRED EMBODIMENTS OF THE INVENTION

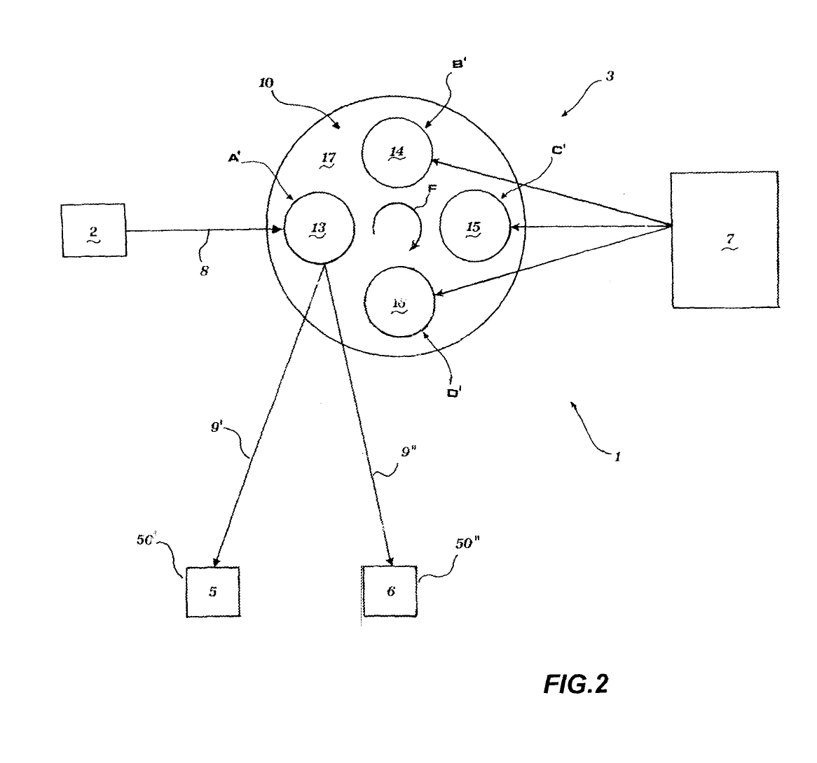

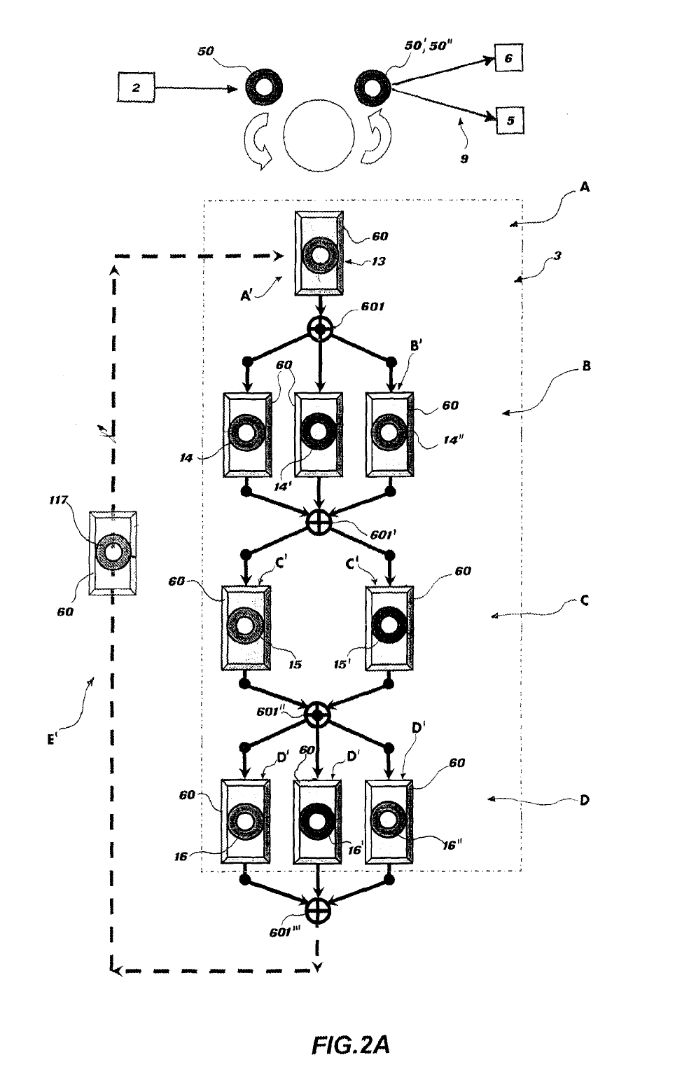

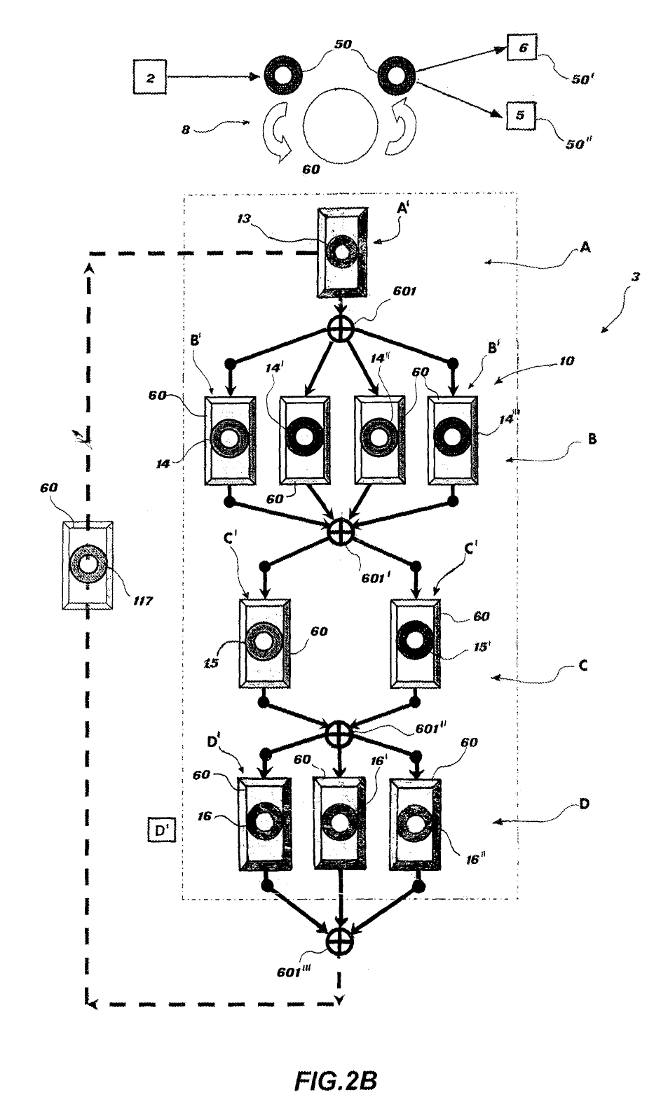

With reference to FIGS. 2, 2A and 2B, there is schematically shown a detection apparatus 1 according to the invention in order to examine an item 50, in particular an air-tight component, for example, a metal wheel rim, for the purpose of establishing the air-tightness features thereof by means of a tracer gas, such as helium or an air/helium mixture.

The apparatus 1 comprises an intake zone 2, in which the items 50 being examined are received, a detection region 3 in which the items 50 are examined in order to establish the air-tightness features thereof, as better explained below, a first discharge zone 5 for the items 50′ examined which have passed the control and a second discharge zone 6 for the items 50″ which have not passed the control. The apparatus 1 comprises a transfer device for transferring the items 50 through various zones of the apparatus 1, in particular a conveyor device 8 for transferring the items being examined to the detection region 3, a first discharge device 9′ and a second discharge device 9″ for transferring the items examined 50′, 50″ from the detection region 3 to the first discharge zone 5 or second discharge zone 6.

The apparatus 1 further comprises a tracer gas detection system 7 which is provided to interact with the items 50 being examined in order to carry out the detection operations provided for, as will be better explained below.

The apparatus 1 further comprises a processor which is not shown in the Figures and which is capable of receiving detection data from the detection system 7 and provided in order to actuate a gripper element for taking the examined item and loading it in the prepositioned discharge device 9′, 9″ in accordance with the result of the detection carried out, as will be better explained below.

In one version of the apparatus 1 of the invention, there may be provision for a single discharge device which can be actuated so as to move the examined items into separate prepositioned storage zones for the examined items 50′ which have passed the control and for the items 50″ which have not passed the control.

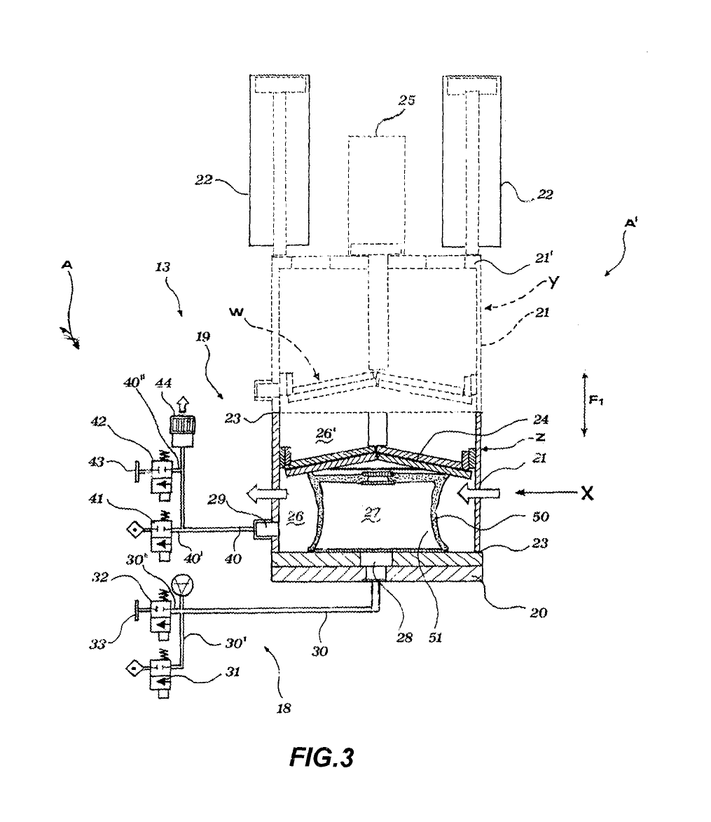

The detection region 3 comprises a plurality of detection or work stations A′-D′, each one suitable for carrying out a specific phase of the detection process, and a plurality of detection cells 10; in the version shown in FIG. 2, there are provided four detection cells 13-16 which are positioned on a rotatable platform 17 which can rotate about an axis of rotation in the direction indicated by the arrow of rotation F in order to move the cells 13-16 towards separate work stations A′-D′ which are provided in the apparatus 1 and which are shown in detail in FIGS. 3-6 in such a manner that all the phases of the detection process can subsequently be carried out on the cells 13-16. The work stations A′-D′ are provided in predefined zones of the apparatus 1 and are stationary, the cells 13-16 being movable between the various work stations A′-D′.

In other versions or embodiments of the apparatus 1, there may be provided a moving device other than the rotatable platform 17 that is suitable for moving, by means of translation and/or rotation, the various cells 13-16 of the plurality of detection cells 10 towards the different work stations A′-D′ of the apparatus 1, in each of which a phase A-D of the detection process provided is carried out.

The moving device moves the cells 10 along a movement path which extends successively through all the phases A-D of the detection process and, at the end of the process, back to the station in which the first phase of the process is carried out. During the phases of the detection process, the cells 10 are stationary, each cell 13-16 in a detection or work station A′-D′, and therefore the moving device is stationary.

For example, shuttles may be provided, as in the versions of FIGS. 2A and 2B, or similar moving devices. In the version of FIG. 2 of the apparatus 1 of the invention, the detection process is divided into a given number of phases having the same duration in terms of time and whose number corresponds to the number of work stations which can be identified in the detection region 3; therefore, a single cell 10 is provided in each phase of the process. The division of the detection process into a suitable number of phases allows an increase in the efficiency of the process itself and the overall productivity of the apparatus 1 without a corresponding increase in the administration costs or the detection structures provided.

In the version shown in FIG. 2, the detection process is subdivided into four separate process phases, indicated below using the letters A-D; in the detection region 3, therefore, there are provided four separate work stations which are indicated below using the letters A′-D′, in each of which one of the four phases A-D is carried out, the cells 13-16 are moved by the rotatable platform 17 successively in the region of the separate stations A′-D′ provided in such a manner that the items positioned therein are successively subjected to the various phases A-D.

At any time, a phase A-D of the detection process is carried out in each cell 13-16. FIG. 2 shows the situation in which the first cell 13 is in the loading/unloading work station A′ and is subjected to the first loading/unloading phase A, the second cell 14 is in the work station B′ for initial pressure reduction (pre-vacuum) and is subjected to the second phase of initial pressure reduction (pre-vacuum) B, the third cell 15 is in the detection work station C′ and is subjected to the detection phase C and the fourth cell 16 is in the recovery work station D′ and is subjected to the recovery phase D.

Each cell 13-16 is suitable for being subjected to all the phases A-D of the detection process in such a manner that each item 50 is successively subjected to the various phases of the process in order to control the air-tightness features thereof.

The total number of phases into which the detection process is divided and/or the total number of cells provided in the apparatus and/or the number of work stations provided for each phase of the process may be selected in accordance with the requirements of the process and/or the geometric features of the items to be tested and/or the precision of air-tightness required, as will be better explained below.

In other versions, the detection process may be divided into a different number of phases, for example 6 or 8, providing a suitable number of detection cells and work stations in each phase, in accordance with the productivity which it is desirable to obtain, the precision of detection and the degree of pressure reduction which it is desirable to obtain, and the geometry or geometrical complexity of the items to be examined, as will be better explained below.

This allows the detection precision to be increased without decreasing the productivity of the apparatus and without increasing the costs thereof excessively. Furthermore, the number of additional pieces of equipment necessary is minimized by providing in the apparatus work stations which are provided for a particular phase of the detection process and moving, by means of the moving device, the cells towards the various stations, also providing a plurality of cells and therefore a high level of productivity of the apparatus, as will be better explained below.

The various work stations A′-D′ are positioned in defined positions of the apparatus 1, in a version equally spaced in the direction of movement of the moving device provided, in the case of FIG. 2 a rotation of approximately 90° of the rotatable platform 17 allows the cells 10 to be moved between two successive work stations. In the case of a linear moving device, the various work stations A′-D′ are positioned in the direction of movement of the moving device itself and the various work stations A-D are positioned at a suitable distance compatible with the pieces of equipment dedicated to the various stations. The various phases A-D are carried out in the corresponding predefined work stations A′-D′ of the apparatus 1.

The apparatus 1 further comprises a gripper element (not shown in the Figures) in order to take an item 50 being examined from the conveyor device 8 and to supply it to a specific detection cell 13-16 and to take an examined item 50, 50″ from the detection cell 13-16 and to supply it to the first discharge device 9′ or second discharge device 9″ in accordance with the result of the detection operation carried out and, therefore, the command received from the processor.

The detection cells 13-16 provided are identical to each other so that only one of them will be described in detail with reference to the air-tightness test of a wheel rim or other item 50. The cell 13 shown in FIG. 3 comprises a fixed lower plate 20, on which there is supported the wheel rim or other item 50 to be examined, a closing device of bell-like form 21 which can be moved with respect to the lower plate 20 by means of first actuators 22, as indicated by the translation arrow F1, between a closing position X shown in FIGS. 3-6, in which the edge 23 of the bell-like member 21 is supported on the lower plate 20, and an open position Y which is shown with broken lines in FIG. 3 and in which the edge 23 of the bell-like member 21 is raised with respect to the lower plate 20, allowing the wheel rim or other item 50 on the lower plate 20 to be introduced/removed. The wheel rim or other item 50 to be examined is positioned on the lower plate 20 in such a manner that the lower edge of the channel of the wheel rim or other item 50 rests on the lower plate 20. The channel of the wheel rim or other item 50 is the portion which must ensure the air-tightness of the wheel rim/tire, otherwise there are found leaks of air which impair the air-tightness of the wheel rim/tire assembly.

The cell 13 further comprises a movable cover 24 which is actuated by a second actuator 25 and which can slide in an air-tight manner inside the bell-like member 21 between an upper position W which is shown with broken lines in FIG. 3 and in which the cover 24 is spaced apart from the wheel rim or other item 50 and a lower position Z which is shown in FIGS. 3-6 and in which the cover 24 is lowered onto the wheel rim or other item 50 in order to define, with the lower plate 20 and the walls of the bell-like member 21, an outer chamber 26 of the wheel rim or other item 50 closed in an air-tight manner with respect to the exterior, and, with the curved portion 21′ and the walls of the bell-like member 21, an upper chamber 26′ in communication with the exterior. The wheel rim or other item 50 is positioned on the lower plate 20 in such a manner that the inner walls 51 thereof define therewith an inner chamber 27 closed in an air-tight manner. The cover 24 is conical and that shape also allows wheel rims or other items 50 and/or wheels having a projecting central hub and spokes to be accommodated correctly in the cell 13.

Each cell 13-16 is further provided with a first connection element 18 which is connected in an air-tight manner to the inner chamber 27 via a hole 28 which is provided in the lower plate 20 and second connection element 19 which is connected in an air-tight manner to the outer chamber 26 by means of a second hole 29 which is provided in the wall of the bell-like member 21, the first connection element 18 and the second connection element 19 being suitable for being connected to the detection system 7 in order to carry out the various phases A-D of the detection process, as will be better explained below.

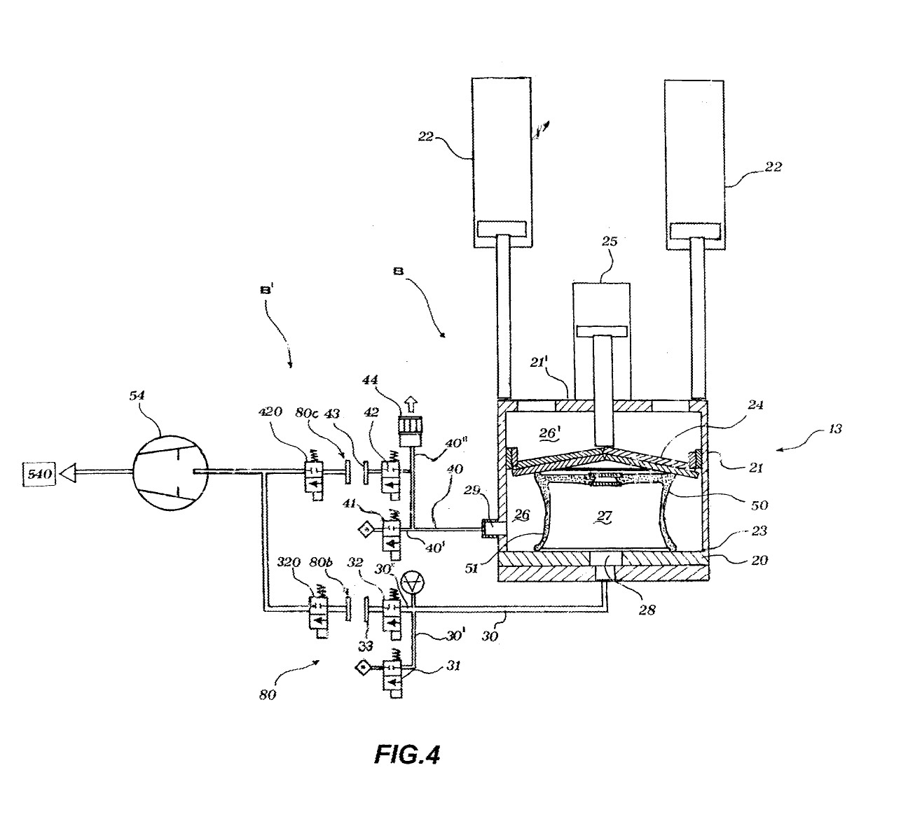

With reference to FIG. 4, the first connection element 18 comprises a pipe 30 which is inserted in the hole 28, having a branch 30′ on which a first solenoid valve 31 is positioned and a second branch 30″ on which a second solenoid valve 32 is positioned, and which terminates in a connection element 33 provided to co-operate with connection devices 80 of the detection system 7 in order to connect the first connection element 18 to the detection system 7 when the connection element 33 and the connection devices 80 are in an advanced position and the second solenoid valve 32 is open, and in order to close the first connection element 18 in an air-tight manner and therefore the inner chamber 27 with the connection element 33 and the connection devices 80 mutually spaced apart and the second solenoid valve 32 closed.

The second connection element 19 comprises a second pipe 40 which is inserted in a second hole 29 provided with a first branch 40′, on which a third solenoid valve 41 is positioned, and a second branch 40″ on which an absolute pressure transducer 44 and a fourth solenoid valve 42 are positioned and which is provided with a second connection element 43 in order to connect the second connection element 19 and to co-operate with the connection devices 80 of the detection system 7 in order to connect it to the second connection element 19 when the second connection element 43 and the connection devices 80 are in an advanced position and the fourth solenoid valve 42 is open, and in order to close the second connection element 19 in an air-tight manner and, therefore, the outer chamber 26 with the second connection element 43 and the connection devices 80 mutually spaced-apart and the fourth solenoid valve 42 closed.

The pressure transducer 44 is operatively connected to the processor in such a manner that, if the transducer 44 detects macro-leaks, the detection process is stopped to prevent damage to the remaining equipment.

The detection system 7 is provided with connection devices 80 which comprise a plurality of connection elements 80a-80e and which are provided to co-operate with the first connection element 33 and the second connection element 43 of each cell 13-16 in order to allow the detection system 7 to be connected to each cell 13-16 in the various work stations A′-D′ in order to carry out the separate phases A-D of the process.

The first connection element 33 and the second connection element 43 and the connection elements 80a-80e are constituted by metal plates which are provided with an 0-ring seal having a suitable flow opening and which are suitable for establishing an air-tight connection for the vacuum and for the low pressure. The metal plates which are provided with O-rings allow an ISO K type air-tight connection to be produced.

The first connection element 33 and the second connection element 43 and the connection elements 80a-80e are moved by actuators which are operated by the processor, respectively, in order to be mutually advanced/moved away from each other in order to establish/close the desired connection between the inner chamber 27 or the outer chamber 26 of each cell 13-16 and the detection system 7. The processor further controls the operation of the solenoid valves, that is to say, the opening/closing thereof.

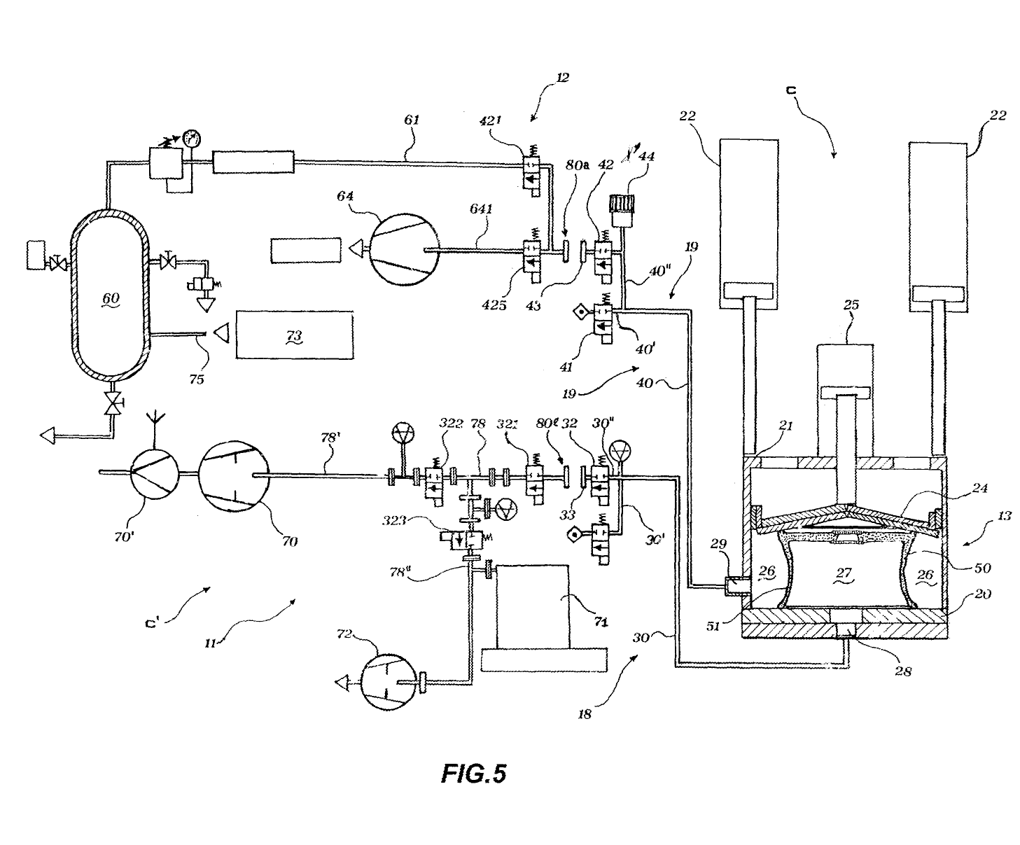

The detection system 7 comprises a system 12 for supplying tracer gas which can better be seen in FIG. 5 and which is provided with a storage tank 60′ for helium gas in order to store a desired quantity of helium at a pressure of approximately 4.5 bar and which is provided with a supply pipe 61 which can be connected to each cell 13-16 by means of the second connection element 19. A solenoid valve 421 is provided on the supply pipe 61 in order to permit/prevent the passage of helium towards the second pipe 40 in order to supply test gas to each cell 13-16.

The gas supply system 12 further comprises a final pressure reduction pump 64 which is provided to be connected by means of an intake pipe 641 and a solenoid valve 425 to the second connection element 19 in order to bring about in the outer chamber 26 a degree of pressure reduction suitable for minimizing the dilution of the helium or the mixture thereof, as will be better explained below. The final pressure reduction pump 64 is intended to refine an initial degree of pressure reduction previously obtained in the outer chamber 26 with a suitable initial pressure reduction pump before supplying the detection gas to the outer chamber 26 in order to be able to carry out the detection.

A first connection element 80a is provided, downstream of the solenoid valves 421 and 425 on a pipe portion common to the intake pipe 641 and the supply pipe 61, in order to co-operate with the second connection element 43 in order to connect the outer chamber 26 to the tank 60′ or to the final pressure reduction pump 64. The tank 60′ is operatively connected to a gas recovery system 73 in order to supply to the tank 60′ test gas which is recovered from the outer chamber 26 at the end of the detection operation.

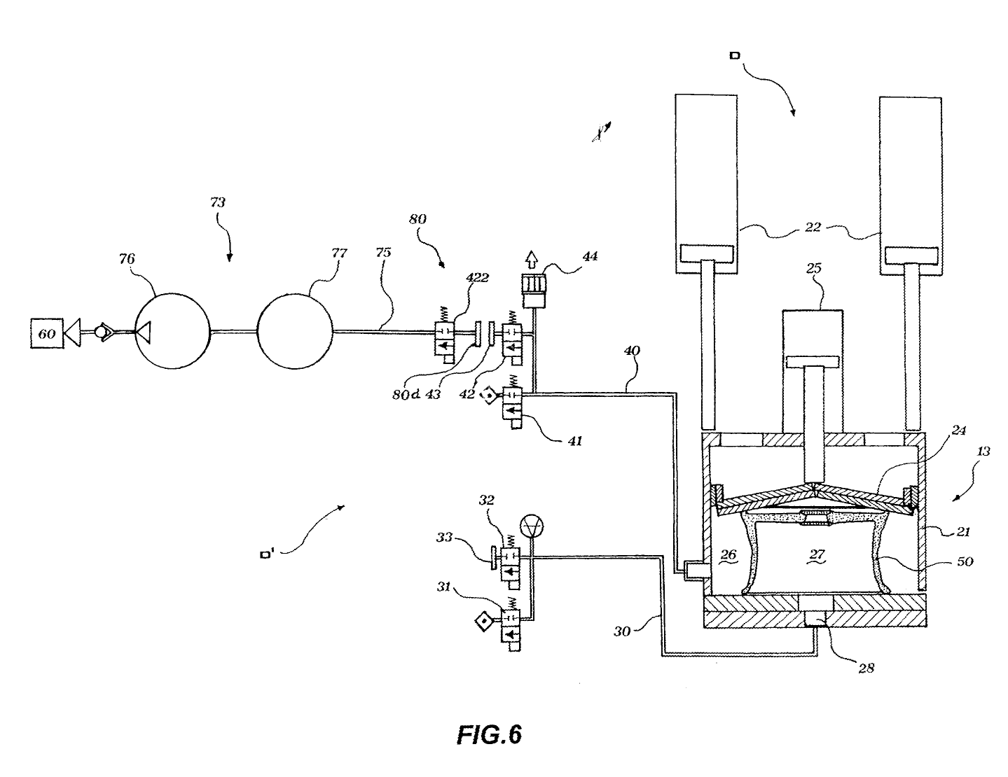

The gas recovery system 73 which can better be seen in FIG. 6 comprises a recovery pipe 75 which terminates in a solenoid valve 422 and a fourth connection element 80d in order to co-operate with the second connection element 43 in order to connect the gas recovery system 73 in the outer chamber 26 in order to draw in, by means of a compressor 76 and a recovery pump 77 which are positioned in series on the recovery pipe 75, the residual air/helium mixture present in the outer chamber 26 and to supply it to the storage tank 60′.

The detection system 7 further comprises a first initial pressure reduction pump 54 which can better be seen in FIG. 4 and on the intake of which there are provided two solenoid valves 320 and 420 which are provided to be connected by means of a second connection element 80b and the first connection element 33 and by means of a third connection element 80c and the second connection element 43 to the inner chamber 27 and the outer chamber 26, respectively, in order to produce at that location a first degree of pressure reduction.

The detection system 7 further comprises a leak detection system 11 which is provided to be connected to the inner chamber 27 in order to detect any leaks in the wheel rims or other items 50 being examined. The leak detection system 11 which can better be seen in FIG. 5 comprises an intake pipe 78 which is provided to be connected by means of a fifth connection element 80e and a solenoid valve 321 to the first connection element 18 and to the inner chamber 27. The leak detection system 11 comprises pressure reduction pumps 70, 70′ which are positioned in series and arranged to draw in the gas present in the inner chamber 27 and to discharge it into a suitable conduit in order to produce in the inner chamber 27 the optimum pressure reduction conditions for the detection operation, and a second pressure reduction pump 72 connected to a spectrometer 71: the pressure reduction pumps 70, 70′ and the second pressure reduction pump 72 are arranged on separate branches 78′ and 78″ of the intake pipe 78.

As mentioned, each cell 13-16 of the plurality of cells 10 provided in the apparatus 1 is suitable for carrying out all the phases A-D of the detection process and is moved by means of the moving device between the various work stations A′-D′ which are provided to carry out the various phases of the process. In each work station A′-D′, the cells 13-16 are connected to separate portions of the detection system 7 by means of the relevant first connection element 18 and second connection element 19, the first connection element 33 and the second connection element 43 and the suitable connection elements 80a-80e of the connection devices 80 in order to carry out the operations provided for each specific phase A-D.

The connection between a cell 13-16 and the desired portion of the detection system is carried out after positioning the cell by means of the moving device in the desired position, placing the first connection element 33 and the second connection element 43 in a mutually advanced position with the suitable connection elements 80a-80e of the connection devices 80 in such a manner that the plates define a single air-tight pipe for the passage of fluids. As mentioned, the plates ensure extremely rapid engagement/disengagement so as not to increase the execution times for the detection process and, at the same time, to bring about a single pipe which does not have any leaks.

In other versions of the apparatus, as mentioned, a different number of work stations may be provided for each phase A-D of the process, each station being suitable for receiving a detection cell. In that case, a plurality of detection cells can be subjected simultaneously to the same phase of the detection process. For each work station, there will be provided only the portion of the detection system 7 necessary for carrying out the operations provided for by the phase A-D of the process in which that station is provided. In some cases, it is advantageous to increase the duration of a specific phase of the detection process, for example, if the geometry of the item being tested is complex or because high standards of air-tightness are required owing to the final application of the item to be tested, or for other reasons.

With the apparatus of the invention, it is possible to provide a plurality of work stations in the phases having greater duration, increasing the number of stations provided for that/those phase(s) in such a manner that a corresponding number of cells is simultaneously subjected to that phase.

Increases in the total duration of the process are avoided and the total duration of the detection process remains unchanged.

Therefore, it is possible to keep the detection process synchronized with the production process and to prevent accumulations of items to be tested, even increasing the duration of a specific phase of the detection process. Therefore, it is possible to maintain high test standards even in the case of items to be tested having complex geometries and/or high air-tightness standards which are required.

The stations of an identical phase are operationally independent of each other, each station is provided with its own equipment necessary for carrying out that specific phase on the cells. Therefore, the stations of a specific phase can be out of phase with each other, that is to say, it is not necessary for the operations of a phase to be finished in all the stations provided in that phase before moving the cells or loading new cells to be subjected to that specific phase.

As soon as the operations of a phase are finished in a station, it is possible to move the cell in which the phase is finished and to load a new cell in the station. Furthermore, the stations of a phase being increased, only the pieces of equipment provided for that phase increase and not the pieces of equipment provided to carry out the other phases. For example, with the duration of the initial pressure reduction phase being increased, the number of stations provided in that phase is increased and the pieces of equipment provided in that phase are increased, but it is not necessary also to increase the pieces of equipment provided to carry out the remaining phases of the process. This prevents excessive increases in plant costs.

The number of work stations provided for a specific phase of the detection process and therefore the number of cells subjected to that phase depends on the duration of the phase itself: increasing the duration of the phase increases the number of cells simultaneously subjected to that phase and the number of work stations provided, and vice versa.

The number of work stations in a specific phase K is equal to the relationship between the duration of the phase K and the duration of the phase A-D of the detection process having a duration less than that of the other phases. Let t_{f} be the duration of the phase of the detection process having a shorter duration, for example, the loading and unloading phase A, and tᵢ the duration of any other phase K, for example, the initial pressure reduction phase. The number of work stations in the initial pressure reduction phase (and therefore the number of cells simultaneously subjected to the initial pressure reduction phase) is equal to tᵢ/t_{f}.

The diagrams of the versions of the apparatus 1 shown in FIGS. 2A and 2B will now be described in detail and parts corresponding to those described with reference to the diagram of FIG. 2 will be indicated using the same reference numerals and will not be described in detail.

Each detection cell 13-16 is mounted on a shuttle 60 which can be moved along suitable movement tracks which are formed so as to define a closed path inside the apparatus 1 in order to be able to transport the cells 13-16 towards the different work stations A′-D′ provided so that each cell is subjected successively to the various phases A-D of the detection process.

Exchange elements 601, 601′, 601″, 601′″ are provided between the track portions of each work station of two successive phases in such a manner that a shuttle 60 from any work station provided in any phase of the process can be conveyed to any station of the successive process phase. Owing to the exchange elements 601, 601′, 601″, 601′″, the shuttles 60 can be moved along different track portions. In that manner, a shuttle 60 on which a phase of the process is finished may be transported into the first free station of the subsequent phase. Increases in the test process are thereby prevented. Furthermore, in the case of irregularities or failures or even in the case of maintenance of a station, it is not necessary to stop the entire apparatus but instead to move the shuttles 60, by means of suitable track portions, towards the other available stations of the phase. Therefore, the detection process does not need to be stopped and the process is only subjected to increases owing to the non-operation of a station.

With particular reference to the diagram of FIG. 2A, there is provided a first loading/unloading phase A, a second initial pressure reduction phase B having a triple duration with respect to the duration of the phase A, a detection phase C having a double duration with respect to the duration of the phase A and a recovery phase D having a triple duration with respect to the duration of the phase A. Each shuttle 60 is moved at the end of the last phase D as far as the zone provided for the phase A, by means of a return line E which has suitable dimensions.

In that version, there is provided a single loading/unloading station A′, three initial pressure reduction stations B′, two detection stations C′, and three recovery stations D′. Therefore, at a specific time, a single cell 13 is subjected to the phase A, three separate cells (14, 14′, 14″) are subjected to the phase B, two cells (15, 15′) are subjected to the phase C and three separate cells (16, 16′, 16″) are subjected to the phase D, and a cell 117 is travelling over the return line E.

Therefore, there are provided in the detection region 3 nine separate test cells which are subjected to the various phases A-D of the detection process and a 10^{th} cell moving to be returned to the station A. The diagram is suitable for carrying out the detection process on items produced with a production frequency of approximately 10 sec in which, in the detection process, the phase A has a duration of approximately 7 sec, the initial pressure reduction phase B a duration of approximately 21 sec, the detection phase C a duration of approximately 14 sec, and the recovery phase D a duration of approximately 21 sec. The time taken to move the shuttles 60 between two successive stations is 3 sec, the time taken to return the shuttle 60 to the phase A along the return line E is approximately 7 sec.

With reference to the diagram of FIG. 2B, the second initial pressure reduction phase B has a four-fold duration with respect to the duration of the loading/unloading phase A and therefore there are provided four initial pressure reduction stations B′, the detection phase C has a double duration with respect to the duration of the phase A and there are therefore provided two detection stations C′, the recovery phase D has a triple duration with respect to the duration of the phase A and there are therefore provided three recovery stations D′ and the travel over the return line E has the same duration as the loading/unloading phase A.

At a specific time, therefore, a single cell 13 is involved in the loading/unloading operations and is in the station A′, four separate cells 14, 14′, 14″, 14′″ are in the initial pressure reduction stations B′ and are subjected to the second initial pressure reduction phase B, two separate cells 15, 15′ are in the detection stations C′, three separate cells 16, 16′, 16″ are in the recovery stations D′ and a single cell 117 is travelling on the return line E. If that diagram is used to carry out the detection process on items produced with a production frequency of approximately 10 sec, the phase A has a duration of approximately 7 sec, the initial pressure reduction phase B a duration of approximately 28 sec, the detection phase C has a duration of approximately 14 sec, and the recovery phase D has a duration of approximately 21 sec. The time taken to move the shuttles 60 between two successive stations is 3 sec, the time taken to return the shuttle 60 to the phase A along the return line E is approximately 7 sec. In that version, therefore, there are provided eleven separate test cells which can be moved between the various work stations A′-D′ in such a manner that the items positioned therein are successively subjected to the various phases of the detection process.

As is evident from the examples set out above, the total number of cells provided in the detection apparatus and/or the number of cells involved at a specific time in the separate phases of the detection process and therefore the number of stations of the separate phases and/or the number of phases into which the process is divided can be freely varied and selected on the basis of the specific requirements of the detection process and the geometric features of the items to be tested.

There will now be described the operation of the apparatus 1 by analyzing the various stations A′-D′ and the various phases A-D of the process with reference to the cell 13 and the diagrams of FIGS. 2, 2A and 2B.

The cell 13 is moved to the work station A′ which is shown in FIG. 3 and in which the first phase A of the detection process is carried out.

When the cell is in position, the bell-like member 21 is translated into an open position Y, subsequently the gripper element takes the wheel rim or other item 50 previously examined and loads it onto the first discharge device 9′ or second discharge device 9″ in accordance with the command received from the processor, or on the basis of the result of the detection operation carried out. Subsequently, the gripper element takes from the conveyor device 8 a wheel rim or other item 50 to be examined and loads it on the lower plate 20 of the cell 13. The bell-like member 21 is then displaced into the closing position X. The operations for loading the wheel rim or other item 50 to be examined and unloading the examined wheel rim or other item 50′, 50″ are therefore carried out at the same work position A′, thereby using a single gripper element.

In the closing position X, the cover 24 is lowered onto the wheel rim or other item 50, defining three separate zones in the cell 13 which are isolated from each other: the outer chamber 26 and the inner chamber 27 which are closed off from the exterior in an air-tight manner and the upper chamber 26′. During the phase A, the solenoid valves 31 and 41 are excited so as to prevent undesirable counter-pressures from becoming generated in the outer chamber 26 and in the inner chamber 27. Therefore, the first phase A is concluded and the rotatable platform 17 is rotated through 90° in order to move the subsequent cell 16 into the work station A′ provided to carry out the first phase A, the cell 13 in the work station B′ provided to carry out the second phase B of the detection process, etc.

If the cell 13 is mounted on a shuttle 60 at the end of the phase A, the shuttle 60 is moved along the movement track and brought to one of the test stations B′ provided in the initial pressure reduction phase B.

In any case, the moving device, a rotatable platform or shuttle, is kept stationary during the detection phase and actuated at the end of that phase in order to move the cell to the suitable station for carrying out the subsequent phase.

If there are provided a plurality of initial pressure reduction stations B′, the cell from the phase A is positioned in the work station of the initial pressure reduction phase B which has just been released. The operations of the initial pressure reduction phase begin as soon as the cell has been positioned and, therefore, the cells present at a specific time in the various initial pressure reduction stations are out of phase with each other by a given time. As soon as the operations of the initial pressure reduction phase have finished at a cell, the corresponding shuttle moves in translation to the successive phase and a new cell is loaded into the corresponding station which has been released. The operational independence between the various stations of the same phase allows the stations of the phase to be able to be out of phase with each other and prevents them from being delayed or slowed down during the entire test process.

In the second station B′, or in one of the stations B′, shown in detail in FIG. 4, the cell 13 is subjected to the phase B: the inner chamber 27 is connected to the first initial pressure reduction pump 54 by means of the connection element 33 and the second connection element 80b, and the solenoid valves 320 and 32 become excited so as to place the inner chamber 27 in fluid communication with the first initial pressure reduction pump 54. The first initial pressure reduction pump 54 is actuated, drawing in the gaseous content present in the inner chamber 27. In that manner, the pressure reduction conditions necessary to be able to subsequently connect the spectrometer 71 to the inner chamber 27 are prepared. In that phase, it is possible to reach a level of pressure reduction less than 100 Pa in the inner chamber 27. In that manner, there is removed approximately from 80% to 90% of any traces of helium which are present in the inner chamber 27, remaining from the preceding detection operation, and which would constitute a background noise which is detrimental to the precision of the subsequent detection operations.

When a specific level of pressure reduction, for example 100 Pa, is achieved in the inner chamber 27, the absolute pressure transducer 44 provided on the second connection element 19 is read and then connected to the outer chamber 26. If the transducer 44 detects a pressure drop in the outer chamber 26, an indication of possible macro-defects in the wheel rim or other item 50 being examined which produce macro-leaks, the detection process for that wheel rim or other item 50 is stopped in order to prevent damage to the other pieces of equipment of the detection system 7, in particular the spectrometer 71, and in order to prevent disadvantageous wastes of helium. In that case, the wheel rim or other item 50 is maintained in the cell and moved progressively therewith between the various operating phases (A-D), but without being subjected to any detection phase until the first station A′, where it is taken and unloaded.

When a pressure of <100 Pa is reached in the inner chamber 27, and no macro-loss has been detected by the transducer 44, the second connection element 43 is connected to the third connection element 80c and the solenoid valves 42 and 420 become excited, placing the first initial pressure reduction pump 54 in communication with the outer chamber 26.

The first initial pressure reduction pump 54 draws in the air contained in the outer chamber 26 and discharges it outwards by means of the discharge 540. The absolute pressure value remaining in the outer chamber 26 is read by the transducer 44.

In this phase, it is possible to reach a level of pressure reduction of <100 Pa in the outer chamber 26. Increasing the level of initial pressure reduction obtained in that phase both in the inner chamber 27 and in the outer chamber 26 increases the duration of the phase B, also reducing the duration of the subsequent phase C with the final level of pressure reduction reached being the same, and vice versa. Therefore, the level of initial pressure reduction reached in this phase will be selected on the basis of the level of final pressure reduction to be reached so as to balance the duration of the two phases. Optionally, if it is desirable to have a greater level of pressure reduction and if it is undesirable to excessively increase the duration of the phase B and/or C, there may be provision for one or more intermediate phases dedicated to obtaining a level of intermediate pressure reduction between the “initial pressure reduction” reached in the phase B and the final pressure reduction reached in the phase C. Alternatively, as mentioned above, there may be provision for increasing the number of stations B′ of the initial pressure reduction phase B and/or the number of detection stations C′.

That arrangement may be adopted in particular if it is necessary to have a level of very extreme pressure reduction for the detection operations and/or the geometry of the items to be detected is particularly complex.

When the phase B is completed, the first connection element 33 and the second connection element 43 are disconnected from the second connection element 80b and third connection element 80c, respectively, separating the cell 13 from the leak detection system 7 and the rotatable platform 17 is rotated through 90°, or the shuttles 60 are translated, carrying the cell 13 into the station C′ provided to carry out the third phase C or into the station which has just been released from the phase C, the cell 14 into the station D′, or into the station which has just been released from the phase D, etc.

At the end of the operations of the initial pressure reduction phase, the cell on which the phase is finished is moved, the cell on which the above-mentioned operations have been finished, whilst the other cells remain stationary in order to complete the initial pressure reduction operations.

When the cell 13 arrives at the station C′, shown in detail in FIG. 5, the inner chamber 27 and the outer chamber 26 are already in conditions of initial pressure reduction (<100 Pa). At the station C, the second connection element 43 is connected to the first connection element 80a, exciting the solenoid valves 42 and 425 places the outer chamber 26 in communication with the final pressure reduction pump 64, continuing the drawing of the residual air in the outer chamber 26 as far as a value of final pressure reduction, that is to say, suitable for detecting and for obtaining the minimum dilution of helium and the air/helium mixture, generally an absolute pressure of less than 100 Pa detected by the transducer 44.

Therefore, a high level of pressure reduction is brought about in the outer chamber 26 in such a manner as to greatly reduce the subsequent dilution of the helium or the mixture thereof which will be introduced into the outer chamber 26 in order to carry out the measurement of the leaks.

That condition may be achieved without excessively increasing the duration of the phase C because a specific level of pressure reduction had already been obtained in the preceding phase B.

Therefore, the first connection element 33 is connected to the fifth connection element 80e, exciting the solenoid valves 32, 321 and 322 connects the inner chamber 27 to the pressure reduction pumps 70, 70′, drawing in the residual air present in the inner chamber 27. The optimum pressure reduction conditions are thereby produced in the inner chamber 27 for detection in order to be able to connect the spectrometer 71 for subsequent detection, drastically reducing and/or eliminating the noise generated by any residual helium.

After reaching the suitable level of final pressure reduction in the inner chamber 27, generally 0.2 Pa, the solenoid valve 323 is also excited, connecting the inner chamber 27 to the second pressure reduction pump 72 which is connected to the spectrometer 71.

The inner chamber 27 is connected both to all the pressure reduction pumps 70, 70′ and to the second pressure reduction pump 72 in such a manner that the gas flow being discharged from the inner chamber 27 is divided as a directly proportional function of the intake capacity of the pressure reduction pumps 70, 70′ which operate simultaneously and which discharge into the conduit and the second pressure reduction pump 72 which intercepts a portion of the flow from the inner chamber 27 in order to carry out the detection with the spectrometer 71.

When the noise read by the spectrometer 71, that is to say, the quantity of helium detected in the gas drawn in, is less than a freely programmable threshold value, for example, 10⁻⁵ mbarl/s, and the residual pressure value in the outer chamber 26 is less than a threshold value which is also freely programmable, for example, <100 Pa, the solenoid valve 425 is deactivated, isolating the outer chamber 26 from the pressure reduction pump 64. Subsequently, the solenoid valve 421 provided on the supply pipe 61 is excited, the pressure difference between the outer chamber 26 (<100 Pa) and the tank 60′ (4.5 bar) creates a flow of helium or its mixture, which is supplied to the outer chamber 26 at the air-tightness test pressure, for example, from 1.5 to 3.5 bar, read by the pressure transducer 44. Therefore, a differential pressure is applied to the walls of the wheel rim or other item 50.

If there are, in the wheel rim channel being examined or in the portion intended to receive the tire, imperfections which place the outer chamber 26 and the inner chamber 27 in fluid communication through the wall of the wheel rim channel and, via those imperfections, helium can flow, this is intercepted in partial flow by the spectrometer 71.

If the value intercepted is less than a value which can constitute a reason for contamination for the spectrometer 71, the solenoid valve 322 is deactivated, disconnecting the pressure reduction pumps 70, 70′ so as to connect in “total flow” the spectrometer 71 to the inner chamber 27.

If the level of helium intercepted stably by the spectrometer 71 is less than a freely programmable threshold value (for example, 3.2 10⁻⁴ mbarl/s), that value depends on the precision of the air-tightness required by the item being examined, the wheel rim or other item 50 is considered to be suitable or, conversely, if the level of helium intercepted by the spectrometer 71 is greater than the threshold value, the wheel rim or other item 50 is considered to be unsuitable. Therefore, all the solenoid valves are deactivated, trapping the air/helium test mixture in the outer chamber 26 and maintaining the reduced pressure in the inner chamber 27.

The first connection element 80a is disconnected from the second connection element 43, the fifth connection element 80e from the first connection element 33 and there is therefore provision for rotating the rotatable platform 17 through 90° or for translating the shuttles 60, carrying the cell 13 to the fourth station D′ or to one of the stations D′ in which the fourth phase D of the detection operation is carried out.

In the fourth station D′, shown schematically in FIG. 6, the fourth connection element 80d is connected to the second connection element 43, the solenoid valves 42 and 422 are excited, connecting the outer chamber 26 to the gas recovery system 73 and, in that manner, the air/helium mixture flows owing to the pressure difference from the outer chamber 26 into the recovery pipe 75 and is supplied to the tank 60′ through the compressor 76. Once all the relative pressure has been discharged from the outer chamber 26, the recovery pump 77 positioned on the recovery pipe 75 is actuated and provides for intake of the residual air/helium mixture present in the outer chamber 26 and for supplying it to the tank 60′, again via the compressor 76.

This operation continues until a residual pressure value is reached in the outer chamber 26 that is less than a freely programmable threshold value, for example, <100 Pa. The residual pressure value is deliberately very low given that the mixture left in the outer chamber 26 at the end of the phase D will be wasted during the phase A when the bell-like member 21 is opened during the unloading/loading of the wheel rim or other item 50. That waste constitutes environmental pollution by helium which increases the noise in the subsequent operations in addition to increasing the costs of the process. Subsequently, the solenoid valves 42 and 422 are deactivated and the solenoid valves 41 and 32 are excited, placing the outer chamber 26 and the inner chamber 27 in communication with the exterior in order to restore ambient pressure therein during the subsequent rotation of the rotatable platform 17 or during the movement of the shuttle 60.

In the version shown in FIG. 2, the phases A-D of the detection process each have a total duration of approximately 8 sec, the rotation of the rotatable platform 17 through 90° between two successive stations A′-D′ lasts 2 sec.

In the versions shown in FIGS. 2A and 2B, when a phase in a specific cell is finished, the relevant connection elements become disconnected and subsequently the shuttle which carries the cell is translated to a movement track portion in order to be moved to the free station of the subsequent operating phase.

After the shuttle has been positioned, the relevant connection elements are connected and the new phase of the detection process is started.

The present invention overcomes the limitations of the cited prior art, at the same time affording a number of other advantages.

These include the possibility of simultaneously subjecting to the detection process a desired number of items 50, therefore obtaining a high level of productivity, limiting the multiplication of the auxiliary devices and therefore the installation space required.

In particular, there is provided a single detection system 7, a single gas supply system 12 and a single leak detection system 11, that is to say, a single spectrometer 71 and a single tank 60′ for storing the gas. If a plurality of work stations are provided in a specific phase, only the portions of the detection system 7 involved in the above-mentioned phase will be duplicated.

In that case, the pieces of equipment also remain stationary whilst the cells can be moved by means of the shuttle 60, being connected from time to time to the equipment dedicated to the test station of the phase to which the cell is being subjected.

The connection devices 80 allow each cell 13-16 to be connected to the portion of the detection system 7 necessary in a specific phase A-D of the process in such a manner that the various phases of the process are successively carried out on each cell 13-16.

A plurality of pumps are provided, which allows division, as mentioned, of the phases for bringing about the pressure reduction in the outer chamber 26 and the inner chamber 27, this allowing a time saving for each cycle and an increase in the level of pressure reduction which may be obtained, and therefore the precision of the detection operations carried out.

Furthermore, the apparatus 1 of the invention minimizes the consumption and waste of helium and this allows an increase in the precision of the detection operations owing to the absence of background noise in the detection cells, an increase in the purity of the detection mixture used and, furthermore, a considerable saving in helium used/lost in each cycle with a consequent substantial saving in costs. A saving of helium is obtained of approximately from £40,000 to £50,000 of helium for each year of use and/or every two million cycles. Therefore, pure helium may also be used, this further increasing the precision of the detection operations carried out.

The process of the invention may be used to test various items 50 which require an air-tightness test before being used, for example, radiators for refrigerating fluids or water, exchangers, tanks for fuels, components for the nuclear industry, aerospace industry, and chemical industry.

The process of the invention may be used to test the components which have to have a leak rate which is less than 5×10⁻⁷ mbarl/s.

The process is further suitable for testing components also having a high volume, even greater than 100,000 cc.

The process of the invention is suitable for testing items which are also not thermally stabilized. On the production line, there may be welding operations which heat the item 50 to be tested which therefore arrives at the detection apparatus in the hot state. The temperature of the item being examined brings about adiabatic variations, that is to say, increases in pressure of the gases which do not impair the detection process of the invention because it is based, in order to identify the leaks in the items, on chemical analysis, or the presence and flow of particles of tracer gas, and not physical analysis, that is to say, the pressure of the gas.

That process is further suitable for testing resilient components or components which contain resilient components.

1. A detection apparatus for detecting leaks in air-tight items fusing tracer gas, the apparatus comprising a plurality of cells which are provided so as to receive an item to be subjected to separate phases of a detection process in order to detect leaks, a plurality of work stations, each work station of the plurality of work stations being suitable for carrying out a specific phase of the detection process, a detection system using tracer gas provided to be connected via suitable connection devices to each cell of the plurality of cells in order to carry out the phases of the detection process, the cells are positioned on a moving device in order to be successively moved towards the separate work stations of the apparatus in order to be subjected to the separate phases of the detection process.

2. The apparatus according to claim 1, wherein each work station of the plurality of work stations is positioned at a predefined position of the apparatus.

3. The apparatus according to claim 1, wherein there are provided at least two work stations for at least one phase of the process in such a manner that at least two cells can be simultaneously subjected to the at least one phase of the process.

4. The apparatus according to claim 3, wherein the at least two work stations of the same phase are independent of each other in such a manner that the at least two work stations can independently start and end the operations of the phase on each cell at mutually different times.

5. The apparatus according to claim 4 further comprising at least two initial pressure reduction stations which carry out an initial pressure reduction phase of the detection process.

6. The apparatus according to claim 3, further comprising at least two detection stations which carry out a detection phase of the detection process.

7. The apparatus according to claim 3, wherein the moving device is configured so as to move the cells along an advancing path which extends through at least one work station of each phase of the process.

8. The apparatus according to claim 3 further comprising exchange elements which allow a cell to be moved from any work station provided in any phase of the process to any work station provided in the subsequent phase of the process.

9. The apparatus according to claim 1, wherein each cell is provided with a connection element, which co-operates with the connection devices of the detection system in order to connect each cell in each phase to a desired portion of the detection system in such a manner that the various phases of the process are successively carried out on each cell.

10. The apparatus according to claim 1, wherein the moving device comprises a translational and/or rotational moving device in order to move the cells towards the separate work stations in such a manner that the phases of the detection process can successively be carried out on the cells.

11. The apparatus according to claim 10, wherein the moving device comprises a rotatable platform which is rotates about an axis of rotation in order to move the cells towards the separate work stations in such a manner that the phases of the detection process can successively be carried out on the cells.

12. The apparatus according to claim 1, wherein each cell of the plurality of cells comprises a plate on which there is positioned the item, a closing device which is movable with respect to the plate in order to receive in an air-tight manner in a closing position the item in the cell so as to define an outer chamber between the item and walls of the closing device and an inner chamber between inner walls of the item and the plate, the outer chamber and the inner chamber being provided with a connection element which cooperates with the connection devices of the detection system in order to connect each cell to the detection system in order to carry out the separate phases of the detection process.

13. The apparatus according to claim 12, wherein the detection system comprises a gas supply system in order to supply tracer gas to the outer chamber of each cell and a leak detection system which is provided to be connected to the inner chamber in order to detect any leaks in the items.

14. The apparatus according to claim 12, wherein the detection system comprises a plurality of intake pumps which are successively connected to the outer chamber and/or the inner chamber in order to draw in gases contained therein, a spectrometer which is connected to the inner chamber in order to detect any defects of the item and a storage tank for the tracer gas.

15. The apparatus according to claim 1, wherein the work stations comprise at least one loading/unloading station in which, a gripper element takes, an examined item from the cell and positions the examined item on a suitable device for discharging the examined item, and wherein an item being examined is loaded in the cell.

16. The apparatus according to claim 1, wherein the work stations comprise at least one initial pressure reduction station in which an initial pressure reduction pump of the detection system, achieves a desired level of pressure reduction in the inner chamber and subsequently in the outer chamber.

17. The apparatus according to claim 1, wherein the work stations comprise at least one detection station in which a final pressure reduction pump of the detection system, draws residual gas into the outer chamber in order to bring about therein a desired value of final pressure reduction and the pressure reduction pump draws residual gas into the inner chamber and subsequently the inner chamber is connected to the detection spectrometer in order to detect the leaks in the item.

18. The apparatus according to claim 1, wherein the work stations comprise at least one recovery station in which a gas recovery system of the detection system, draws gas from the outer chamber and the inner chamber, supplying the gas to the detection system.

19. A process for detecting defects of air-tight items using tracer gas and a detection system according to a sequence of phases comprising: positioning an item in a cell of a plurality of detection cells; and moving the cell towards separate work stations of a detection apparatus in order to subject them to separate successive phases of the detection process, wherein each phase of the process is carried out in a specific work station.

20. The process according to claim 19, wherein each work station is provided at a predefined position of the detection apparatus.

21. The process according to claim 20, wherein each phase of the process is carried out by maintaining the cells stationary in a specific work station.

22. The process according to claim 19, further comprising providing at least two work stations for at least one phase of the process in such a manner that at least two cells can be simultaneously subjected to the at least one phase of the detection process.

23. The process according to claim 22, wherein the at least two work stations of the same phase are independent of each other in such a manner that the at least two work stations can independently start and end the operations of that phase on each cell at mutually different times.

24. The process according to claim 19, further comprising, in each phase after positioning the cell in a station, connecting each cell via associated connection elements to a suitable portion of the detection system in order to carry out the relevant phase of the process.

25. The process according to claim 24, wherein the phases comprise an initial pressure reduction phase, in which a desired level of pressure reduction is brought about in an inner chamber and subsequently in an outer chamber of the cell, and a successive pressure reduction phase in which residual gas is drawn into the outer chamber and into the inner chamber in order to bring about therein a desired level of final pressure reduction.

26. The process according to claim 19, wherein each phase of the process is carried out by maintaining the cells stationary in a specific work station.
